(19) United States
(12) Patent Application Publication
(10) Pub. No.: US 2008/0019364 A1
(43) Pub. Date: Jan. 24, 2008

(54) Internet protocol packet processing

(76) Inventor: Daniel L. Xia, Qingdao (CN)

Correspondence Address: CARLSON, GASKEY & OLDS, P.C., 400 W MAPLE RD, SUITE 350, BIRMINGHAM, MI, 48009, US

(21) Appl. No.: 11/489,654

(22) Filed: Jul. 19, 2006

(51) Int. Cl. H04L 12/56

(52) U.S. Cl. 370/392; 370/401

(57) ABSTRACT

A technique for processing Internet Protocol (IP) packets includes an IP conveyor portion as a loadable kernel module that includes user defined filtering criteria for recognizing at least one feature of an IP packet. When one of the user defined filtering criteria is satisfied, an IP packet can be directed along a desired communication path, processed using a desired protocol stack or both. Whenever an IP packet does not satisfy at least one of the filtering criteria, a default communication path is used for such a packet.

### FIELD OF THE INVENTION

This invention generally relates to communication. More particularly, this invention relates to processing internet protocol packets for communications.

### DESCRIPTION OF THE RELATED ART

There are a variety of devices that are useful for a variety of types of communications. Some communications use internet protocol (IP) packets for communicating over an IP network. One type of device useful for such communications is known as a Solaris box, which communicates with an IP network through an Ethernet connection such as an Ethernet card plugged into an SBUS or PCI slot associated with the Solaris box or a built-in motherboard Ethernet interface. The Solaris box exchanges IP packets with the IP network in a known manner.

FIG. 1 shows an example arrangement 20 that follows a standard configuration. In this example, a Solaris box 22 has an associated socket interface that allows a user 26 to take advantage of the functionality of the Solaris box 22. In this example, a default communication path 30 from the Solaris box 22 through an Ethernet card 32 to the IP network 34 facilitates communicating IP packets between the IP network 34 and the Solaris box 22. This allows the user 26, to send or receive information over the IP network 34, for example.

The most popular way of networking programming on a Solaris device is to use socket API to access the Solaris IP service that handles the actual sending and receiving of IP packets over the default path 30. such an arrangement limits the protocol stack to a user as TCP/IP/Ether or UDP/IP/Ether. This arrangement works for many situations. If a user needs a different protocol stack, however, such as for communications over an asynchronous transfer mode (ATM) connection, the user must develop their own IP implementation and make it communicate with an adaptation layer such as AAL5, which adapts higher layer PDUs into an ATM compatible format. There is a disadvantage to such an arrangement because an individual user has to do their own programming for such situations. In other words, if a protocol stack like TCP/IP/AAL5/ATM is needed, then the user 26 has to develop their own IP implementation and make it communicate with AAL5.

There is a need for an improved arrangement for processing IP packets when using devices such as a Solaris box. This invention addresses that need.

### SUMMARY OF THE INVENTION

An exemplary method of processing internet protocol (IP) packets using a device having a default path for communicating IP packets includes determining whether at least one IP packet satisfies at least one predetermined filtering criteria. If the at least one user defined filtering criteria is not satisfied, the IP packet is directed along the default path. If the user defined filtering criteria is satisfied, the IP packet is directed along a second, different path.

In one example, the default path comprises a first protocol stack and the second, different path comprises a second protocol stack.

In one example, the filtering criteria is part of a kernel module that is selectively loadable for detecting when an IP packet should be directed along the second path. The filtering criteria may comprise an indication of a particular IP address, an indication of a particular IP port, by customizing input-output control (IOCTL) raw command (I_STR)s.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a communication arrangement designed according to the prior art.

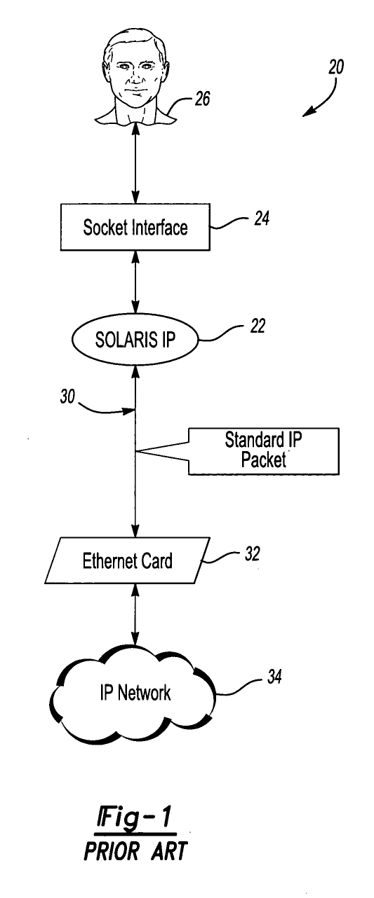

FIG. 2 schematically illustrates selected portions of a communication arrangement designed according to an embodiment of this invention.

### DETAILED DESCRIPTION

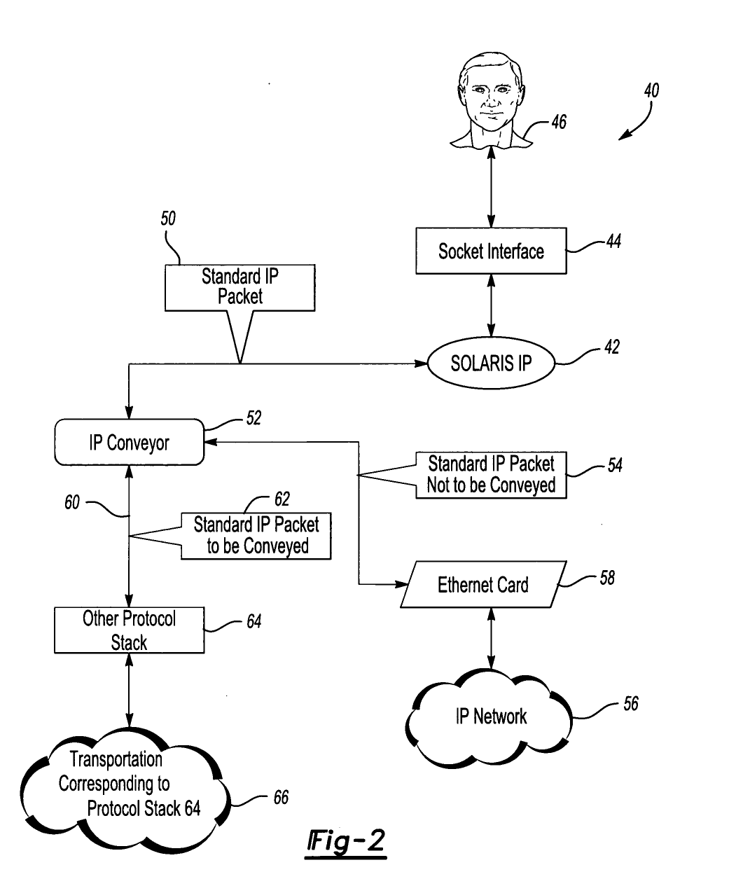

FIG. 2 schematically shows an example communication arrangement 40 including a processor 42. In this example, the processor comprises a Solaris box. Other examples include Linux machines. The processor 42 in one example has an associated computer software kernel for managing resources of the processor 42 in a known manner. Software program kernels insulate applications from system hardware and provide them with essential system services such as input/output management, virtual memory and scheduling, for example.

In this example a socket interface 44 allows a user 46 to conduct communications through the processor 42. The example socket interface 44 provides an interface into the kernels networking protocols in a known manner. For example, the socket interface 44 allows the user 46 to create a communication endpoint in the form of a file descriptor and to issue input or output operation commands.

The example of FIG. 2 includes the ability for processing an internet protocol (IP) packet 50. An IP conveyor portion 52 includes selected filtering criteria for recognizing at least one feature of an IP packet. In one example, the IP conveyor portion 52 is a loadable kernel module.

In one example, whenever an IP packet does not satisfy at least one of the filtering criteria of the IP conveyor portion 52, the packet can be directed along a default communication path associated with the processor 42. In this example, such an IP packet is represented at 54 and follows the default path through an Ethernet connection 58 to the IP network 56.

Whenever an IP packet satisfies at least one of the filtering criteria, a second, different communication path is used. An example second path is shown at 60 and an IP packet conveyed along that path is schematically represented at 62. In this example, a protocol stack 64 is used for processing the packet 62 before it is transmitted to a transportation medium 66 corresponding to the protocol stack 64. The second, different communication path in some examples may involve allowing a user manipulation of a packet prior to transmission to the IP network 56. In such an example, the Ethernet connection 58 is used as part of the second path.

The configuration of the second path 60 will depend on the needs of a particular situation. For example, where an ATM or SONET communication is desired, the second communication path 60 includes a second, different protocol stack (e.g., the protocol stack 64) compared to that associated with the default path. The illustrated example is capable of using a variety of filtering criteria for recognizing when an IP packet should be directed along the default path or the second path 60. Example filtering criteria is imposed by input/output controls (IOCTL) with raw commands (I_STR) from the user 46 for designating when a particular IP packet should be directed along a particular path, particular IP destination addresses or particular IP ports, for example. Given this description, those skilled in the art will realize what filtering criteria will satisfy the needs of their particular situation.

With the IP conveyor portion 52 as a loadable kernel module, automatic processing of IP packets according to a user's desires for directing an IP packet along a specific path or for using a specific protocol stack becomes possible once the loadable kernel module is loaded into the kernel associated with the processor 42 and active in the kernel. Such automatic processing of IP packets relieves the user 46 of the burden of developing their own IP implementation for different types of communications.

The automated techniques for handling IP packets according to an embodiment of this invention are useful for transmissions by a user 46 and IP packets that are received from the IP network 56. The IP conveyor portion 52 may apply filtering criteria to IP packets that are going to be transmitted or those that are received from the IP network 56, for example.

In one example, the IP packet processing kernel module comprises computer programming suitable for a Solaris box using stream programming. Other devices such as a Linux machine that support kernel loadable modules and stream programming may be used in some example embodiments of this invention. Given this description, those skilled in the art will realize how to adapt the features of the disclosed examples to meet their particular needs.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A method of processing Internet Protocol (IP) packets using a device having a default path for communicating data packets between the device and an IP network, comprising the steps of
determining whether at least one IP packet satisfies at least one user defined filtering criteria; and
directing the at least one IP packet along the default path if the at least one user defined filtering criteria is not satisfied or directing the at least one IP packet along a second, different path if the at least one user defined filtering criteria is satisfied.

2. The method of claim 1, comprising
directing the at least one IP packet along the second, different path for user manipulation of the at least one IP packet.

3. The method of claim 2, comprising
allowing for the user manipulation prior to a transmission of the at least one IP packet from the device.

4. The method of claim 1, comprising
directing the at least one IP packet along the second, different path for transmission from the device along the second, different path.

5. The method of claim 4, wherein the default path comprises an Ethernet connection and the second, different path comprises any user needed connection could be configured for further delivery

6. The method of claim 1, comprising
providing a computer program kernel for managing system resources of the device; and
providing a loadable computer program kernel module that includes the at least one user defined filtering criteria.

7. The method of claim 1, wherein the at least one filtering criteria comprises at least one of
an indication of an IP address or all IP addresses; or
an indication of an IP port or all IP ports;

8. The method of claim 1, wherein the default path comprises a first protocol stack and the second, different path comprises a second protocol stack.

9. A device for communicating Internet Protocol (IP) packets, comprising:
a processor;
a default communication path between the processor and an IP network, the processor controlling communications of IP packets including normally directing IP packets along the default communication path;
a computer program kernel that manages resources of the processor;
a kernel module associated with the computer program kernel, the kernel module including at least one user defined filtering criteria that indicates at least one type of IP packet that is to be directed along a second path that is different than the default path.

10. The device of claim 9, wherein the kernel module is selectively loadable for use with the computer program kernel.

11. The device of claim 9, wherein the at least one filtering criteria comprises at least one of
an indication of an IP address or all IP addresses; or
an indication of an IP port or all IP ports;

12. The device of claim 9, wherein the default path comprises an Ethernet connection and the second, different path comprises a user needed connection configured for further delivery of at least one IP packet.

13. The device of claim 9, wherein the second path comprises directing the IP packet for manipulation by a user of the device.

14. The device of claim 9, wherein the default path comprises a first protocol stack and the second path comprises a different protocol stack.
